(19) United States
(12) Patent Application Publication
(10) Pub. No.: US 2021/0138877 A1
(43) Pub. Date: May 13, 2021

(54) POWER MANAGEMENT OF TRANSPORTATION REFRIGERATION UNIT

(71) Applicant: Carrier Corporation, Palm Beach Gardens, FL (US)

(72) Inventor: Gael Ducher, Olivet (FR)

(21) Appl. No.: 17/053,204

(22) PCT Filed: May 9, 2018
(86) PCT No.: PCT/IB2018/000597

§ 371 Date: Nov. 5, 2020

(51) Int. Cl. B60H 1/32; F25D 11/00

(52) U.S. Cl. CPC B60H 1/3222; B60H 2001/3266; B60H 1/3232; F25D 11/003

(57) ABSTRACT

Disclosed is a transportation refrigeration unit (TRU 104) for conditioning air in a cargo box (106), the TRU including a TRU controller (108) that is electronically connected to a truck engine controller (170), wherein when a delta between a cargo box temperature and a cargo box set point temperature is greater than a predetermined threshold, the TRU controller actuates the truck engine (168) when the truck engine is off, and conditions air in the cargo box to return the cargo box temperature to the set point temperature.

### BACKGROUND

Exemplary embodiments pertain to the art of transportation refrigeration units and more specifically to power management of transportation refrigeration units.

Engineless transport refrigeration units (TRU) may rely on power from a truck engine to run TRU cooling systems and regulate the box temperature. If the box temperature is outside an acceptable range while the truck engine is off, the TRU may be unable to properly regulate the box temperature.

### BRIEF DESCRIPTION

Disclosed is a transportation refrigeration unit (TRU) for conditioning air in a cargo box, the TRU including a TRU controller that is electronically connected to a truck engine controller, wherein when a delta between a cargo box temperature and a cargo box set point temperature is greater than a predetermined threshold, the TRU controller: actuates the truck engine when the truck engine is off, and conditions air in the cargo box to return the cargo box temperature to the set point temperature.

In addition to one or more of the above disclosed features or as an alternative the TRU controller draws power from the truck engine to power the TRU components until the cargo box temperature is proximate the set-point temperature.

In addition to one or more of the above disclosed features or as an alternative the TRU controller turns the engine off when the cargo box temperature is proximate the set point temperature.

In addition to one or more of the above disclosed features or as an alternative the TRU controller determines that the truck engine is actuated and thereafter draws power from the truck engine to power the TRU components until the cargo box temperature is proximate the set-point temperature.

In addition to one or more of the above disclosed features or as an alternative the TRU controller actuates the truck engine after determining that predetermined safety conditions are satisfied.

In addition to one or more of the above disclosed features or as an alternative the predetermined safety conditions include an amount of fuel onboard the truck being above a threshold amount.

In addition to one or more of the above disclosed features or as an alternative the TRU includes a thermometer in the cargo box, the thermometer being in electronic communication with the TRU controller, and the actual temperature in the cargo box is temperature read dynamically by the TRU controller in communication with the thermometer.

In addition to one or more of the above disclosed features or as an alternative the TRU controller communicates with the truck engine controller over a controller area network (CAN).

In addition to one or more of the above disclosed features or as an alternative the TRU is engineless.

In addition to one or more of the above disclosed features or as an alternative the TRU components include a compressor, an evaporator, a condenser, and a fan.

Further disclosed is a method for maintaining a cargo box set point temperature in a transportation refrigeration unit (TRU), wherein the TRU includes one or more of the above disclosed features.

### BRIEF DESCRIPTION OF THE DRAWINGS

The following descriptions should not be considered limiting in any way. With reference to the accompanying drawings, like elements are numbered alike:

FIG. 1 is an ecosystem for the disclosed embodiments;

FIG. 2 is a process for managing power in a transportation refrigeration unit (TRU) according to an embodiment;

FIG. 3 is a process for managing power in a TRU according to an embodiment;

FIG. 4 is a process for managing power in a TRU according to an embodiment; and

FIG. 5 is a process for managing power in a TRU according td an embodiment.

### DETAILED DESCRIPTION

With reference to FIG. 1, illustrated is a system 100 for applying a disclosed embodiment. A transportation refrigeration unit (TRU) 104 is illustrated which includes a cargo area 106 and a TRU controller 108, wherein the TRU controller 118 is further defined below. One example TRU controller 108 may be an Eco-Drive power module by Carrier Corporation, which is brand of the Climate, Controls & Security division of United Technologies Corporation.

The TRU controller 108 may control a plurality of TRU components, including a plurality of TRU power supply components and a plurality of power demand components. The TRU power supply components may include a TRU engine 110, though in some embodiments the TRU may be engineless, and a TRU battery 112. The plurality of TRU power demand components may include powered cooling components including a compressor 116 which may be a variable compressor. The TRU power demand components may further include an evaporator/condenser 120 with an associated fan 124. In addition, the power demand components may include the TRU controller 108, cargo lights 128, a plurality of cooling valves including an expansion valve 144 and a suction modulation valve 148. In addition, the TRU controller 108 may communicate with a cargo sensor 152 disposed in the cargo storage area 106. The cargo sensor may be, for example, a thermal sensor. Temperature read by the sensor 152 is sometimes referred to as a box temperature.

The TRU 104 may be disposed on a trailer 160 hauled by a truck 164. The truck 164 may have an engine 168 which may run on a fossil fuel. The truck 164 may also have an engine controller 170, which may be an electronic controller. Electronic communications between the TRU controller 108 and the engine controller 170 may be accomplished with Controller Area Network (CAN) bus communication protocols over a CAN bus 172, illustrated schematically. The CAN bus was developed by Robert Bosch GmbH and originally released by the International Organization for Standardization (ISO) as ISO 11898, is a message-based protocol adopted as a vehicle bus standard. The CAN bus allows microcontrollers and devices to communicate with each other in applications without a host computer. CAN bus protocols use the on-board diagnostics (OBD)-II vehicle diagnostics standard.

The TRU controller 108 may be programmed to keep the TRU cargo area 106 at a first temperature, which may be a set point temperature. Over time, the temperature of the cargo area 106 may rise, requiring the TRU controller 108 to run the TRU components to cool the cargo area 106. If the TRU is engineless, or experiences TRU engine failure, the TRU controller 108 may be required to tap energy off of a running truck engine 168. However, the truck engine 168 may be turned off at rest stops, pit stops or the like.

Turning to FIG. 2, a process is illustrated for maintaining a box temperature throughout a duration of a haul including when the truck engine 168 is turned off. The process includes a first step S200 of monitoring for when the cargo area temperature has fallen below a set point. For example, the TRU controller 108 may identify when a predetermined delta in temperature has been reached by reading a second temperate, which is the actual temperature, and comparing the second temperature with the first temperature. So long as the temperature of the cargo area 106 is within a predetermined acceptable range, at step S204 the controller will cycle back to S200.

When the determination at step S204 is “yes” then the TRU controller 108 advances to step S208 of executing a TRU active conditioning step, that is, a step of aligning the box temperature with the temperature set point. Step S208 includes step S212 of determining if the truck engine is on. This occurs by the TRU controller 108 communicating with the engine controller 170 over the CAN bus 172. If the truck engine is running, then the determination at step S216 is “yes”.

Turning to FIGS. 2 and 3, with a “yes” determination at step S216, the TRU controller 108 will execute a truck powered conditioning step at step S300. Step S300 includes step S304 of drawing power from the truck engine 168, powering the TRU components at step S308, conditioning the TRU cargo area 106 to the set point at step S312, powering off the TRU components at step S316, and cease drawing power from the truck engine 168 at step S320. The truck powered conditioning step then ends at step S324.

As illustrated with FIGS. 2, 3 and 4, with the truck powered conditioning step completed at step S324, the TRU controller 108 advances to the truck engine management step at step S400. Step S400 includes step S404 of determining whether the truck engine 168 was running/actuated (that is, “on”) before executing the truck powered conditioning step S300. If the truck engine 168 was running then at answer is “yes” then at step S408 the TRU controller 108 cycles to step S200. If the determination at step S408 is “no” then the TRU controller 108 instructs the engine controller 170 to turn off the truck engine 168 at step S412. Thereafter the TRU controller 108 cycles back to step S200.

Turning to FIGS. 2 and 5 if the determination at step S216 is “no” then the TRU controller 108 executes a truck engine 168 starting or actuating step at step S500. Step S500 includes step S504 of communicating with the engine controller 170 to determine if safety conditions prevent starting of the truck engine 168 at that time. Various conditions may prevent the truck engine 168 from starting. Such conditions may include the configuration of the truck transmission. For example, in a manual transmission, if the truck is parked in a non-neutral gear, then starting the engine could cause unintended lurching of the truck, grinding of transmission gears, as well as immediate engine stall. In addition, if fuel levels in the truck are low, starting the truck may lead to unintentionally depleting the truck engine 168 of fuel during a haul. These conditions are not intended to be limiting.

If the truck engine 168 cannot be started then at step S508 the determination is “no” and the TRU controller 108 cycles back to step S200. If the determination at step S508 is “yes” then at step S512 the truck engine is caused to start running. Then the TRU controller 108 advances to the truck powered conditioning step S220.

In summary, the following logic steps are applied by the TRU: the TRU determines that the box temperature is not aligned with the temperature set point, the TRU sends a message to truck to (re)start the truck engine, if safety conditions are acceptable, the truck engine restarts, the TRU power engine runs, the TRU refrigeration unit starts and recovers to the temperature set point, when the temperature set point is recovered, the TRU stops the truck engine.

This system may allow avoiding a situation where a truck engine is left on when not needed when truck is stopped. The above disclosed embodiments provide an electronic control, which may be in the form of software and/o hardware, of an engine of a truck transporting, which is box truck engine. The management of the system may be based on a difference or delta of the temperatures between a first temperature which a predetermined temperature set point within the TRU and a second temperature which is the actual TRU temperature, sometimes referred to as the box temperature. The disclosed embodiments provide various benefits, including an unbroken chain of cold temperatures for contents in the TRU, preventing food waste. The disclosed embodiments also provide autonomy to engineless/direct drive units so that human error is removed. Further, there is a reduction in fuel burn as the truck engine is only operated as needed. The disclosed embodiments are applicable to various forms of transportation, including but not limited to small trucks, vans and other forms of light commercial vehicles, often referred to as LCVs.

As used herein, the term controller, including but not limited to as used with the TRU controller 108, refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality. For example, processors processes data stored in the memory and employ the data in various control algorithms, diagnostics and the like.

In terms of hardware architecture, controllers may be computing devices that include, in addition to processors and memory, one or more input and/or output (I/O) device interface(s) that are communicatively coupled via a local interface. The local interface may include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

In operation, processors can be configured to execute software stored within the memory, to communicate data to and from the memory, and to generally control operations of the computing device pursuant to the software. Software in memory, in whole or in part, may be read by the processors, perhaps buffered within the processor, and then executed. The processors may be hardware devices for executing software, particularly software stored in memory. The processors may be a custom made or commercially available processors, central processing units (CPU), auxiliary processors among several processors associated with the computing device, semiconductor based microprocessors (in the form of microchips or chip sets), or generally any such devices for executing software.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, such as a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance, but not limited to, a modulator/demodulator (modem; for accessing another device, system, or network), a radio frequency (RE) or other transceiver, a telephonic interface, a bridge, a router, etc.

One should note that the above disclosed architecture, functionality, and/or hardware operations may be implemented by software. In software, such functionality may be represented as a module, segment, or portion of code, which comprises one or more executable instructions for implementing the specified logical function(s). It should also be noted that such modules may not necessarily be executed in any particular order and/or executed at all.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

The term “about” is intended to include the degree of error associated with measurement of the particular quantity based upon the equipment available at the time of filing the application. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A transportation refrigeration unit (TRU) for conditioning air in a cargo box, the TRU comprising:
a TRU controller that is electronically connected to a truck engine controller,
wherein when a delta between a cargo box temperature and a cargo box set point temperature is greater than a predetermined threshold, the TRU controller:
actuates the truck engine when the truck engine is off, and
conditions air in the cargo box to return the cargo box temperature to the set point temperature.

2. The transportation refrigeration unit of claim 1, wherein while the truck engine is actuated, the TRU controller draws power from the truck engine to power TRU components until the cargo box temperature is proximate the set-point temperature.

3. The transportation refrigeration unit of claim 2, wherein the TRU controller turns the engine off when the cargo box temperature is proximate the set point temperature.

4. The transportation refrigeration unit of claim 1, wherein the TRU controller determines that the truck engine is actuated and thereafter draws power from the truck engine to power the TRU components until the cargo box temperature is proximate the set-point temperature.

5. The transportation refrigeration unit of claim 1, wherein the TRU controller actuates the truck engine after determining that predetermined safety conditions are satisfied.

6. The transportation refrigeration unit of claim 5, wherein the predetermined safety conditions include an amount of fuel onboard the truck being above a threshold amount.

7. The transportation refrigeration unit of claim 6, wherein the TRU includes a thermometer in the cargo box, the thermometer being in electronic communication with the TRU controller, and the actual temperature in the cargo box is temperature read dynamically by the TRU controller in communication with the thermometer.

8. The transportation refrigeration unit of claim 7, wherein the TRU controller communicates with the truck engine controller over a controller area network (CAN).

9. The transportation refrigeration unit of claim 8, wherein the TRU is engineless.

10. The transportation refrigeration unit of claim 9, wherein the TRU components include a compressor, an evaporator, a condenser, and a fan.

11. A method for maintaining a cargo box set point temperature with a transportation refrigeration unit (TRU), wherein the TRU includes a TRU controller, electronically connected to a truck engine controller,
wherein the method comprises:
the TRU controller determining when a delta between a cargo box temperature and a cargo box set point temperature is greater than a predetermined threshold, the TRU controller,
actuating the truck engine when the truck engine is off, and
conditioning air in the cargo box to return the cargo box temperature to the set point temperature.

12. The method of claim 11, wherein while the truck engine is actuated, the TRU controller draws power from the truck engine to power TRU components until the cargo box temperature is proximate the set-point temperature.

13. The method of claim 12, wherein the TRU controller turns the engine off when the cargo box temperature is proximate the set point temperature.

14. The method of claim 13, wherein the TRU controller determines that the truck engine is actuated and thereafter draws power from the truck engine to power the TRU components until the cargo box temperature is proximate the set-point temperature.

15. The method of claim 14, wherein the TRU controller actuates the truck engine after determining that predetermined safety conditions are satisfied.

16. The method of claim 15, wherein the predetermined safety conditions include an amount of fuel onboard the truck being above a threshold amount.

17. The method of claim 16, wherein the TRU includes a thermometer in the cargo box, the thermometer being in electronic communication with the TRU controller, and the actual temperature in the cargo box is temperature read dynamically by the TRU controller in communication with the thermometer.

18. The method of claim 17, wherein the TRU controller communicates with the truck engine controller over a controller area network (CAN).

19. The method of claim 18, wherein the TRU is engineless.

20. The method of claim 19, wherein the TRU components include a compressor, an evaporator, a condenser, and a fan.
